(19) United States
(12) Patent Application Publication
(10) Pub. No.: US 2004/0209044 A1
(43) Pub. Date: Oct. 21, 2004

(54) Non-homogeneous multilayer circuit assemblies and method of manufacture

(76) Inventor: Adam Gadway, Liverpool, NY (US)

Correspondence Address: BOND, SCHOENECK & KING, PLLC, ONE LINCOLN CENTER, SYRACUSE, NY, 13202-1355, US

(21) Appl. No.: 10/414,356

(22) Filed: Apr. 15, 2003

(51) Int. Cl. B32B 3/10

(52) U.S. Cl. 428/137; 428/209

(57) ABSTRACT

Non-homogeneous multilayer circuit assemblies are formed from circuit substrates, comprised of a layer of polyimide substrate on one or both surfaces of which an electrical circuit has been formed. Multiple circuit substrates, separated by layers of fusible dielectric material, are exposed to sufficient temperature and pressure to bond the multiple layers into a non-homogeneous but cohesive circuit assembly.

### FIELD OF THE INVENTION

This invention relates to multilayer integrated circuit assemblies, especially integrated circuit assemblies used in the field of microwave electronics. In particular, this invention discloses a new non-homogeneous multilayer integrated circuit assembly and a method of making such an assembly using fusion bonding to join diverse dielectric materials into a coherent assembly.

### BACKGROUND OF THE INVENTION

Multilayer circuit assemblies are comprised of at least one circuit substrate, usually having epoxy-glass laminate (FR4), polyimide, or a fluoropolymer composite as its base material. Typically, metal cladding has been applied on one or both sides of the base material and a circuit trace is formed on one or more surfaces of the base material by removing portions of the metal cladding. Other methods of forming a circuit substrate are known in the art. The circuit substrate is then sandwiched between other dielectric layers, generally of fluoropolymer, FR4, or polyimide. A circuit assembly may contain a plurality of circuit substrates, each separated by a dielectric layer. An objective of such assemblies is to reduce the spacing between circuits on adjacent layers (the “trace-to-trace spacing”), while maintaining electrical isolation between the circuit layers. In this way, the amount of circuitry that can be contained within an assembly of a designated size can be increased. Such assemblies require consistent trace-to-trace spacing to provide consistent performance.

If the multilayer circuit assembly is to be used in a microstrip assembly, the external surface of the upper or lower substrate must be a metal layer that forms an electrical ground plane. If the multilayer circuit assembly is to be used in a stripline assembly, the external surface of the upper and lower substrates must be a metal layer such that the upper surface of the assembly is an electrical ground plane and the lower surface of the assembly is an electrical ground plane.

Typically, the multiple layers of the circuit assembly are formed into a cohesive assembly using one of four methods. If the circuit substrate is polyimide or Fr4, it can be coated with a film of epoxy pre-preg or interleaved with a sheet of bonding ply or B-staged epoxy pre-preg (typically called standard lamination—Fr4 processing parameters), which bonds it to an adjacent fluoropolymer layer. Alternatively, a polyimide circuit substrate can be coated with a film of polyimide bond ply or interleaved with a sheet of polyimide bond-ply, which bonds the circuit substrate to an adjacent layer of fluoropolymer. If the circuit substrate is comprised of a fluoropolymer layer, it can be coated with a film of epoxy pre-preg or interleaved with a sheet of bonding ply or B-staged epoxy pre-preg, which bonds it to an adjacent layer of fluoropolymer dielectric. Alternatively, a fluoropolymer circuit substrate can be sandwiched between fluoropolymer dielectric layers and fusion bonded to the adjacent fluoropolymer layers by heat and pressure.

U.S. Pat. No. 6,395,374 to McAndrew discloses a method of manufacturing multilayer integrated circuits using a fusion bonding process. The circuit substrate disclosed in McAndrew comprises PTFE filled with glass fibers and ceramic. McAndrew further discloses that the methods described above can be combined. For example, a plurality of layers of circuit substrate can be bonded to dielectric layers using fusion bonding and additional layers of circuit substrate or dielectric can be added using a film bonding process.

Using the method disclosed in McAndrew has several disadvantages. First, the web of glass fibers contained in PTFE circuit substrates is irregular. When the layered PTFE assembly is exposed to heat and pressure, the PTFE circuit substrate is compressed. However, the irregular glass fiber web results in inconsistent compression across the substrate and leads to uneven spacing between circuit traces on the surfaces of adjacent substrate layers. As a result, circuit performance is erratic. Additionally, PTFE is structurally weak when in the thin form (<0.005″) required for certain applications. Processing such thin PTFE substrates through conveyor equipment results in unacceptable levels of breakage and finished products with unacceptable levels of distortion. Moreover, the thinnest presently available PTFE substrates are approximately 0.0015″ thick, which limits the potential miniaturization of circuits.

U.S. Pat. Nos. 6,099,677 and 6,208,220, both to Logothetis, disclose a device and method of forming multilayer circuit modules, using fusion bonding to bond multiple layers of PTFE, including at least one layer of PTFE circuit substrate. As disclosed in McAndrew, the Logothetis patents disclose a PTFE circuit substrate filled with glass fibers and ceramic. The Logothetis device and method suffer from the same shortcomings as described for McAndrew.

U.S. Pat. No. 5,309,629 to Traskos discloses a method of manufacturing a multilayer circuit board that involves fusion bonding of multiple circuit substrate layers, some of which may include polyimide substrates, interleaved with fusible polymeric dielectric layers. However, Traskos requires substantial additional work to create conductive interconnections between circuit traces on different substrate layers. Specifically, interconnect holes must be formed and filled with conductive bonding material before the layered assembly is exposed to heat and pressure. This complicates the process of forming a multilayer circuit by requiring extra preparation of the fusible dielectric layers before they can be assembled to the circuit substrates. Additionally, Traskos' method of creating interconnections is not efficient for interconnection holes in the range of 0.004″ as are now commonly used in the industry. Further, Traskos requires that at least one layer of the multilayer circuit board be comprised of non-fusible material.

### SUMMARY OF THE INVENTION

The present invention relates to improved multilayer integrated circuit assemblies, especially those used in the field of microwave electronics. Multiple circuit layers of polyimide substrate are interspersed with layers of dielectric material that can be made to flow under certain conditions of temperature and pressure. When the layered assembly is exposed to heat and pressure of appropriate values, the flowable dielectric material fills voids in the circuit assembly and bonds the polyimide-based circuit layers together.

The integrated circuit assembly comprises at least one circuit substrate, comprising a layer of polyimide film, on at least one surface of which an electrical circuit trace has been formed. The polyimide layer can be comprised of heat-fusible polyimide, that is, polyimide that deforms when exposed to sufficient heat and pressure, or it can be comprised of non-fusible polyimide, that is, polyimide that will not deform when exposed to heat and pressure as disclosed herein. Another thermoplastic elastomer can be substituted for polyimide, as long as it can be clad with copper or another conductive metal and it has a melt point that is comparable to that of PTFE.

The circuit substrate is sandwiched between layers of heat-flowable dielectric material, such as PTFE. The layered assembly is then heated in a vacuum lamination press or a similar device, using a high temperature bonding cycle. During the bonding cycle, the PTFE layers soften and are compressed into any voids in the circuit layers. Further, the softened PTFE layers bond with the softened polyimide layers to form a cohesive, but non-homogeneous laminate.

The present invention can be used for stripline and microstrip circuit assemblies. In the case of microstrip assemblies, one exterior layer of the assembly would comprise PTFE with a metalized exterior surface to form a single ground plane. In the case of stripline structures, both exterior layers of the assembly would comprise PTFE with a metalized exterior surface to form two ground planes. As is known in the art, vias can be formed in the circuit assemblies using a variety of techniques and metalized to selectively create electrical communication between a plurality of circuit traces on a plurality of layers of the assembly.

Because of the stability of the polyimide layers, spacing between circuit traces remains constant. Because of the possibility that the PTFE and polyimide layers may shift relative to each other, it is important that the layered assembly be fixed in position prior to heating and it is important to closely monitor the application of heat and pressure to the layered assembly.

Where the circuit substrate has been formed on a heat-fusible polyimide layer, the pressure of the fusion bonding allows the circuit trace to become at least partially imbedded in the adjacent surface of the polyimide layer. Whereas fusion bonding of substrates comprised of glass reinforced PTFE results in inconsistent trace-to-trace spacing, fusion bonding of heat-fusible polyimide circuit substrates results in traces that imbed consistently across the entire polyimide layer. Thus, circuit characteristics remain consistent throughout the assembly. Further, the extent to which a circuit trace is imbedded in an adjacent polyimide layer after fusion bonding is predictable and consistent for consistent materials exposed to a given time, temperature and pressure regime.

An added advantage of using heat-fusible polyimide is that smaller trace-to-trace spacing can be achieved despite the use of thicker substrates. Previously, to obtain trace-to-trace spacing of 0.001″, one would have to use a substrate of 0.001″ thickness. According to the present invention, 0.001″ trace-to-trace spacing can be attained using 0.003″ substrate, because the circuit traces can be imbedded 0.001″ into each surface of the substrate. This is beneficial because thicker substrates are more easily handled during the production process and are less susceptible to breakage and distortion.

The present invention is directed to an improved multilayer integrated circuit assembly for use in the field of microwave electronics.

Thus it is an object of the present invention to decrease the thickness of core material, thereby allowing for the design of thinner multilayer circuit assemblies.

It is yet another object of the present invention to increase the ease of processing and manufacturing a thin core for incorporation into a fusion-bonded multilayer circuit assembly.

It is another object of the present invention to provide for consistent trace-to-trace spacing on either side of the core material.

It is another object of the present invention to adapt the benefits of fusion bonding to multilayer circuit assemblies incorporating polyimide circuit substrates.

These and other objects, features and advantages of the present invention will be more readily apparent from the detailed description that follows.

### BRIEF DESCRIPTION OF THE DRAWINGS

FIG. 1 is an exploded view of the present invention.

FIG. 2 is a side view of one embodiment of the present invention.

FIG. 3 is a side view of the preferred embodiment of the present invention.

FIG. 4 is a side view of another embodiment of the present invention.

### DETAILED DESCRIPTION OF THE INVENTION

The multilayer assembly disclosed herein is comprised of circuit substrates and dielectric layers. A circuit substrate consists of a sheet of dielectric material with two parallel, planar surfaces that includes electrical circuitry on one or both surfaces. The circuitry can be simple electrical traces or can include active or passive electronic components such as resistors and diodes. Such components may be formed on a surface of the circuit substrate or may be imbedded in the substrate.

Dielectric layers provide electrical insulation between circuitry on adjacent circuit substrates. The dielectric value of the dielectric layers depends on the dielectric material used and its thickness. The preferred material for the dielectric layers is PTFE, approximately 0.005 inches thick. Such a layer has a dielectric value of 10 MV/m. Those skilled in the art will recognize that dielectric layers of greater and lesser thickness fall within the scope of this invention, as do fluoropolymers other than PTFE.

The multilayer assembly disclosed herein may be comprised of as few as two layers. The maximum number of layers is limited only by the physical size of the application in which such an assembly is to be used and by the physical size of the press in which the layers are bonded to each other. The preferred embodiment comprises an assembly approximately 0.012 inches thick with 1 circuit substrate and 2 dielectric layers.

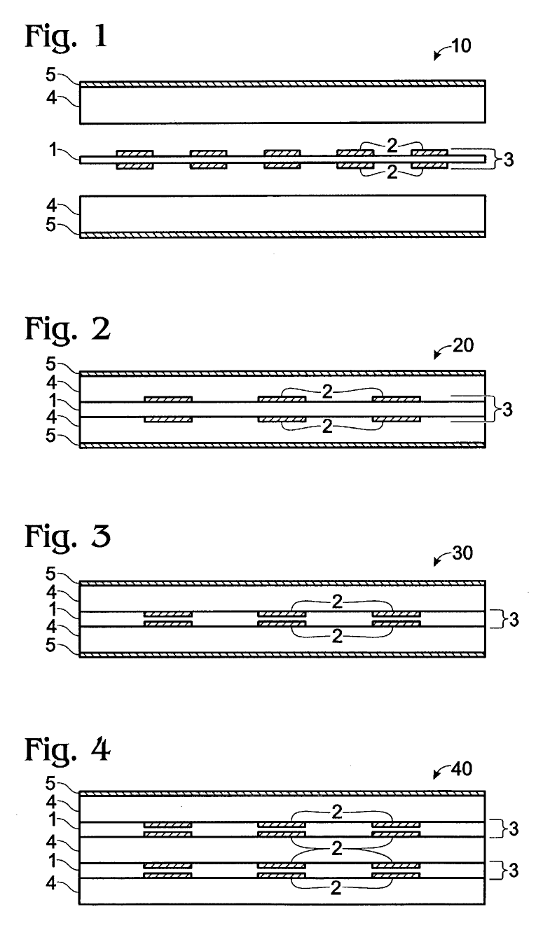

Referring now to FIG. 1, the preferred embodiment 10 is comprised of a polyimide centerboard 1, on which one or more metalized circuit traces 2 have been formed, creating a circuit substrate 3. The circuit substrate 3 is layered between PTFE dielectric layer 4. In the preferred embodiment, the dielectric layer 4 contains a metalized ground plane 5 on its exterior surface. Those skilled in the art will recognize that alternate embodiments exist in which none, one or both of the dielectric layers 4 have a ground plane on their exterior surface.

It is possible to add layers to the present invention using techniques previously known in the art. For example, after preparing a multilayer assembly according to the present invention, one can add additional circuit substrate and dielectric layers to the assembly using film-bonding techniques such as polyimide bond ply and epoxy pre-preg.

Circuit substrates 3 and dielectric layers 4 are stacked to form a subassembly. Preferably a number of circuit assemblies are arrayed on a larger panel to minimize production costs and then singulated after processing. Alternatively the components may be processed individually.

As is known in the art, the materials used in a non-homogeneous assembly must have compatible coefficients of thermal expansion (CTE). This is to increase stability of the assembly across as wide a range of operating temperatures as possible. In the preferred embodiment, the circuit substrate is comprised of heat-fusible polyimide, which has a CTE of 25 and the dielectric layers are comprised of PTFE, which has a CTE of 24. An assembly comprised of layers with such similar CTE values will be stable across the materials' usable temperature range (which is approximately—15 to 540 degrees Fahrenheit for assemblies comprised of PTFE and polyimide).

It is important that the layers of the subassembly be properly aligned before fusion bonding. Typically, post-bonding processing will require formation of vias to create electrical connections between two or more layers of circuit substrate. Improper alignment will result in a failed electrical connection. Therefore, prior to undergoing the fusion bonding, the layers of the subassembly must be fixed in position relative to each other. Preferably, the layers are fixed in position by a 4 pin tooling system (known in the art as multiline). Alternatively they may be aligned using optics and tacked or riveted together prior to lamination (which is known in the art as pinless lamination). After alignment, the subassembly is placed in a vacuum lamination press, where it is exposed to heat and pressure sufficient to bond the layers together.

The bonding process requires sufficient heat to cause the various layers of the subassembly to become fused together. The bonding process also requires sufficient pressure to force the layers together and cause the softened layers to fill any voids in the subassembly. Too much heat will degrade or break down the substrate materials. Too much pressure will cause excessive material movement and may affect the spacing between circuit layers. The conditions of temperature and pressure must be obtained for a period of time. Exposure of the assembly to correct temperature and pressure for too brief a period of time will not form a sufficient or consistent bond between the substrates.

During the bonding process, circuit traces 2 on the surface of the circuit substrates 3 are imbedded into the circuit substrate layers 1 to a consistent depth across the entire substrate 3. The degree to which the circuit traces 2 imbed into a circuit substrate or dielectric layer 1, 4 depends on the type and consistency of the layer. For example, non-fusible polyimide resists imbedding of circuit traces, even under conditions of temperature and pressure. In one embodiment of the present invention (FIG. 2) the centerboard 1 is comprised of non-fusible polyimide. After the assembly 20 has been bonded, the circuit traces 2 have imbedded into the PTFE dielectric layers 4, but have not imbedded into the non-fusible polyimide centerboard 1. In this embodiment, the distance between circuit traces 2 is determined by the thickness of the non-fusible polyimide center board 1.

Referring to FIG. 3, in the preferred embodiment, copper circuit traces 2 are formed from 1 ounce copper on both sides of a 0.003″ fusible polyimide center board 1. When exposed to heat and pressure as disclosed herein, the copper circuit traces 2 imbedded to a depth of 0.001″ on each surface of the polyimide center board 1. The resulting circuit traces 2 are separated by a consistent layer of polyimide 0.001″ in thickness, creating a consistent, stable circuit assembly 30.

The depth to which a circuit trace 2 is embedded into any layer of polyimide depends on several factors, each of which can be controlled: the height of the circuit trace, the solidity and other characteristics of the polyimide substrate, the solidity and other characteristics of the PTFE dielectric layer, and the parameters of the bonding process (temperature, pressure and time).

As is shown in FIG. 4, an assembly 40 can be comprised of more than one circuit substrate 3. Each circuit substrate 3 must be layered between PTFE layers 4 and then fusion bonded under appropriate conditions of time, temperature and pressure, as disclosed herein. Also as is shown in FIG. 4, the techniques described herein can be used to fashion assemblies 40 with only one ground plane 5, or with no ground planes (not shown).

In the preferred embodiment, the subassembly is exposed to a maximum temperature of 700 to 750 degrees F. and a pressure of at least 1000 psi. Preferably, the subassembly will begin at approximately ambient room temperature and increase in 100-degree steps, with a ten-minute stabilization period at each step. Preferably, the pressure increases at a constant rate of approximately 100 psi every eight minutes. The duration of the bonding cycle must be sufficiently long to raise all of the bonding and void-filling elements of the assembly to the melt point of the heat-flowable dielectric. Durations of as little as ten minutes and as long as ninety minutes have been successful.

Those skilled in the art will recognize that a variety of conditions of temperature and pressure will serve to bond diverse layers together. A typical range of temperature is 640 F to 750 F and a typical range of pressure is 250 PSI to 2500 PSI.

After bonding is complete, the assembly is allowed to cool. As is known in the art, vias and through-holes may then drilled and plated according to a plan, to place selected circuit substrates of the assembly in electrical communication with each other and portions of the metallic ground plane(s) may be removed to electrically isolate through-holes and vias. Also, as is known in the art, through-holes may be drilled and plated prior to singulation so that singulation forms solder points useful to attach assemblies to printed circuit boards and other similar devices.

What is claimed is:

1. A non-homogeneous multilayer dielectric structure comprising:
at least one layer of polyimide substrate;
a plurality of layers of heat-flowable dielectric;
wherein the at least one polyimide layer and the plurality of layers heat-flowable dielectric are fusion bonded to each other.

2. The non-homogeneous multilayer dielectric structure of claim 1 wherein the heat-flowable dielectric is from the group consisting of fluoropolymers and fluoropolymer composites.

3. The non-homogeneous multilayer dielectric structure of claim 1 further comprising a metalized circuit trace on at least one surface of the at least one polyimide layer.

4. The non-homogeneous multilayer dielectric structure of claim 1 further comprising metalized circuit traces on a plurality of surfaces of the at least one polyimide layer.

5. The non-homogeneous multilayer dielectric structure of claim 4 further comprising metalized through holes electrically connecting said metalized circuit traces according to a predetermined pattern.

6. The non-homogeneous multilayer dielectric structure of claim 1 further comprising at least one metalized ground plane on the exterior surfaces of the structure, parallel to the plane of the layers.

7. The non-homogeneous multilayer dielectric structure of claim 1 wherein the polyimide substrate is heat fusible.

8. A method of making a non-homogeneous multilayer dielectric structure comprising the steps of:
preparing at least one layer of polyimide substrate;
positioning said at least one polyimide layer between a plurality of layers of heat-flowable dielectric to form a subassembly;
exposing the subassembly to sufficient heat and pressure for a sufficient period of time to cause the heat-flowable dielectric to fill voids and bond with the at least one polyimide layer.

9. The method of making a non-homogeneous multilayer dielectric structure of claim 8, further comprising the step of fixing the position of the at least one polyimide layer relative to the position of the plurality of layers of flowable dielectric.

10. The method of making a non-homogeneous multilayer dielectric structure of claim 8, further comprising the step of forming metalized circuit traces on at least one surface of the at least one polyimide layer.

11. The method of making a non-homogeneous multilayer dielectric structure of claim 8, further comprising the step of forming a metalized circuit trace on a plurality of surfaces of the at least one polyimide layer.

12. The method of making a non-homogeneous multilayer dielectric structure of claim 11, further comprising the step of drilling and metalizing holes to place said metalized circuit traces in electrical communication according to a predetermined pattern.

13. The method of making a non-homogeneous multilayer dielectric structure of claim 8, wherein the subassembly is exposed to a temperature of at least 700 degrees F.

14. The method of making a non-homogeneous multilayer dielectric structure of claim 8, wherein the subassembly is exposed to a temperature of at least 700 degrees F. and not more than 750 degrees F.

15. The method of making a non-homogeneous multilayer dielectric structure of claim 8, wherein the subassembly is exposed to a temperature that increases to at least 700 degrees in the course of at least one hour and is maintained at 700 degrees or higher for at least 10 minutes.

16. The method of making a non-homogeneous multilayer dielectric structure of claim 8, wherein the subassembly is exposed to a pressure of at least 1000 psi.

17. The method of making a non-homogeneous multilayer dielectric structure of claim 8, wherein the subassembly is exposed to a pressure that increases to at least 1000 psi over the course of at least one hour.

18. The method of making a non-homogeneous multilayer dielectric structure of claim 8, wherein the at least one polyimide layer is comprised of fusible polyimide.
